(19) United States
(12) Patent Application Publication
(10) Pub. No.: US 2023/0153823 A1
(43) Pub. Date: May 18, 2023

(54) SYSTEMS AND METHODS FOR RULES-BASED TRANSACTIONS IN A COMMUNITY

(71) Applicant: CarynHealth Technology, LLC., Alpharetta, GA (US)

(72) Inventors: Balaji Narayana, Johns Creek, GA (US); Kevin Swint, Alpharetta, GA (US); Jason Pak, Marietta, GA (US)

(21) Appl. No.: 17/986,765

(22) Filed: Nov. 14, 2022

Related U.S. Application Data
(60) Provisional application No. 63/278,865, filed on Nov. 12, 2021.

(51) Int. Cl. G06Q 20/40; G06Q 20/22; G06Q 20/36; G06Q 20/02

(52) U.S. Cl. CPC G06Q 20/405; G06Q 20/223; G06Q 20/3678; G06Q 20/027; G06Q 2220/00

(57) ABSTRACT

Disclosed herein are systems to effectuate cost-sharing communities on one or more forms of computer readable media utilizing sharing protocols and a set of rules-based, configurable set of methods, and processes over which the specific transactions can be modeled and implemented.

### CROSS-REFERENCE TO RELATED APPLICATIONS

This Application claims the benefit of U.S. Provisional Application No. 63/278,865 filed Nov. 12, 2021. The entire contents of this application is incorporated herein by reference in its entirety.

### FIELD OF THE INVENTION

Cost-sharing communities can form spontaneously or deliberately, and generally organize along lines of shared goals and beliefs. Cost-sharing communities can enable value-exchange amongst the members based on agreed-upon rules of engagement and arbitration, in accordance with the established rules placed on the transaction. Some examples include an industry association representing the common needs of its members; an employer (or human resources) representing the needs of its unique business situation and situation of its employees; or a HealthShare Ministry that brings people sharing a common faith or ethical code of conduct together that are willing to and voluntarily share medical expenses incurred by members in the community.

Regardless of the type of goals or beliefs, the value transactions within a community may be defined into a set of rules-based, configurable set of methods, and processes over which the specific transactions can be modeled and implemented.

The inventors have discovered several novel schemas for these rules-based methods, which can be referred to herein in the aggregate, as “Community Program Administration System” or “ComPAS” for short.

### SUMMARY OF THE INVENTION

Embodiments of the present disclosure related to systems to effectuate cost-sharing communities on one or more forms of computer readable media.

In some embodiments, systems described herein can be implemented on one or more forms of computer readable media. In some embodiments, the systems described herein can utilize distributed computing architecture and can, for example, be effectuated via cloud-based systems. In some embodiments, a user can access their accounts and virtual wallets via desktop computing devices, tablets, and smart phones. The systems described herein can generate and display a graphical user interface (GUI) that displays a virtual wallet, thereby presenting a virtual wallet view. Members can utilize the virtual wallet view to visualize and manipulate their wallet, such as to initiate transactions. As described herein, the ComPAS architecture can interface and interact with user devices to effectuate the transactions described herein and operate the rules-based structure described herein to operate transactions.

### BRIEF DESCRIPTION OF THE DRAWINGS

FIG. 1 shows an embodiment of an information schema diagram, according to one or more embodiments of the disclosure.

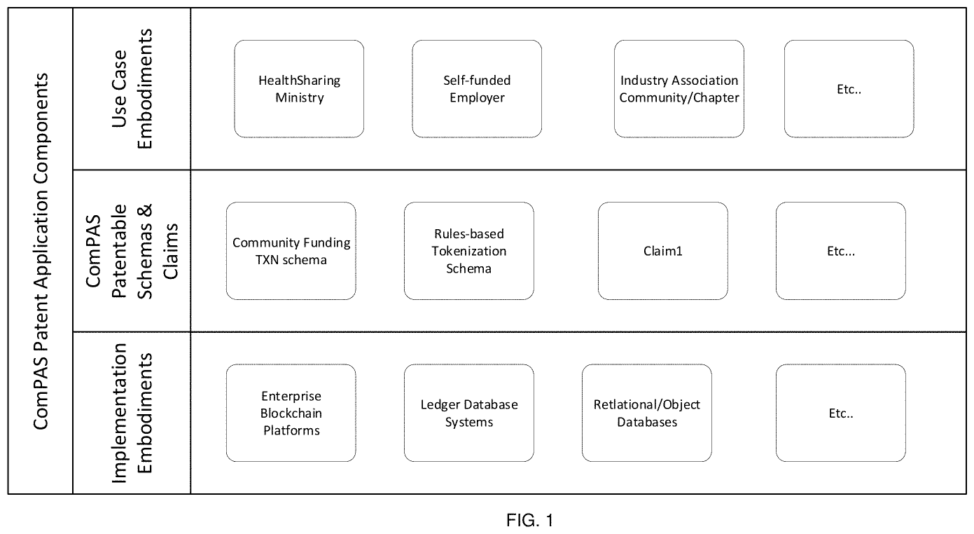

FIG. 2 shows an embodiment of a ComPAS system schematic, according to one or more embodiments of the disclosure.

FIG. 3 shows an example of a community eligibility management process, according to one or more embodiments of the disclosure.

FIG. 4 shows an example of a community-funding transaction processing flow, according to one or more embodiments of the disclosure.

FIG. 5 shows an example of the processing of a community-service transaction, according to one or more embodiments of the disclosure.

FIG. 6 shows an example of an outgoing payment feed utilizing a cash concentration process, according to one or more embodiments of the disclosure.

FIG. 7 shows an example of a “Sharing Program Administration” (“ShrPA”) community cloud-based system utilizing a ComPAS implementation for a health care sharing ministry (“HCSM”), according to one or more embodiments of the disclosure.

### DETAILED DESCRIPTION

Systems described herein can be implemented on one or more forms of computer readable media. In some embodiments, the systems described herein can utilize distributed computing architecture and can, for example, be effectuated via cloud-based systems. In some embodiments, a user can access their accounts and virtual wallets via desktop computing devices, tablets, and smart phones. The systems described herein can generate and display a graphical user interface (GUI) that displays a virtual wallet, thereby presenting a virtual wallet view. Members can utilize the virtual wallet view to visualize and manipulate their wallet, such as to initiate transactions. The ComPAS architecture can interface and interact with user devices to effectuate the transactions described herein and operate the rules-based structure described herein to operate transactions.

Systems described herein can comprise payables wallets. Payables wallets can be used for third party entity accounting purposes. Payables wallets may also be utilized to pay for operating costs of the systems described herein. For example, a value of $X, such as a predetermined dollar value for a per household per month, can be incorporated into a premium to pay for provider network rental fees. Such an amount can be, for example, paid to a third party vendor rented from a provider network. Management and operation of payables wallets, as described herein, can be defined and controlled by the rules defined by the systems described herein. Payables wallets can act as a repositories for assets generated by an algorithm within ComPAS that are owed by a party, or to fulfill an obligation to a third party.

Rules of engagement, as described herein, can relate to how transactions and services are processed in the system, as described herein, for the benefit of members of a community, as described herein. A “sponsor” (e.g., community management, on behalf of members) may define and articulate the rules of engagement, which can be codified as rules in the system using a business rules modeling language or database. Examples of these rules could be, but are not limited to:
“10% of all member contributions are set aside for general administration purposes”
“If a claim is submitted by a military veteran, out-of-pocket (“OOP”) expenses will be 100% reimbursed”
“The first two monthly contributions go into an administration reserve; after that 5% of all member contributions are set aside for general administration purposes”
“Donations towards military veterans go directly to help pay for OOP expenses”

The rules described herein can support certain funding transactions. Funding transactions, as described herein, include, but are not limited to contributions (such as when a member adds funds, tokens, or fiat to a community), donations (such as when a member donates funds, tokens, or fiat to another member), management (e.g., establishing criteria for contribution, deduction, and the like, and effectuating operation of a system, as described herein), deductions (such as when a member extracts funds, tokens, or fiat from a system for the member's use), investments (such as when a member or group of members contributes funds, tokens, or fiat with the intention of growth), securing (e.g., rules implemented by a system, as described herein, to protect members' funds/tokens/fiat and the operation of the system), and the like. One or more rules apply to how each of these funding transactions are processed, creating accounting wallets as needed in the system

A community, which can include members, can support certain service transactions, including, but not limited to reimbursements for (i) medical services, (ii) pharmaceutical purchases, (iii) purchase of medical devices, (iv) purchases of rehabilitative and health equipment (e.g., exercise equipment), (v) purchase of diagnostic devices, and the like. One or more rules can be implemented into the systems described herein to specify how service transactions are processed and from which wallets in the system money can be sourced to satisfy any services, as described herein. Depending upon the rules that are configured by the system, the system's operations can vary by installation.

In certain embodiments, a community (e.g., small business employees participating in health insurance), can identify a set of rules that define the operation of the community. Embodiments of the systems described herein can codify these rules into a template. Systems, as described herein, can be configured specifically for particular industry types. For example, law firms and employees of the law firm may have specific needs for health insurance claims, e.g., certain ophthalmologic exam requirements due to time spent in front of computers. In another instance, steel workers may have certain health care requirements, such as visiting a chiropractor yearly, resulting from the physical requirements of the job. Such claims would be processed with different rules within their respective templates. Launching new implementations of one or more rules templates in a community or system can be referred herein as “spinning up” a community or system.

Examples of rules, as disclosed herein, can comprise strategies to codify said rules. Codification of rules may be implemented by using rules creation tools packaged with a system, as described herein. Rules can be commonly applied amongst users or be unique to various users depending upon the requirements of the community.

To initiate an accelerated (digital) value exchange, rules and values can be codified and orchestrated to drive transactions within community, thus providing a framework for implementing a rules-based transaction system such as ComPAS.

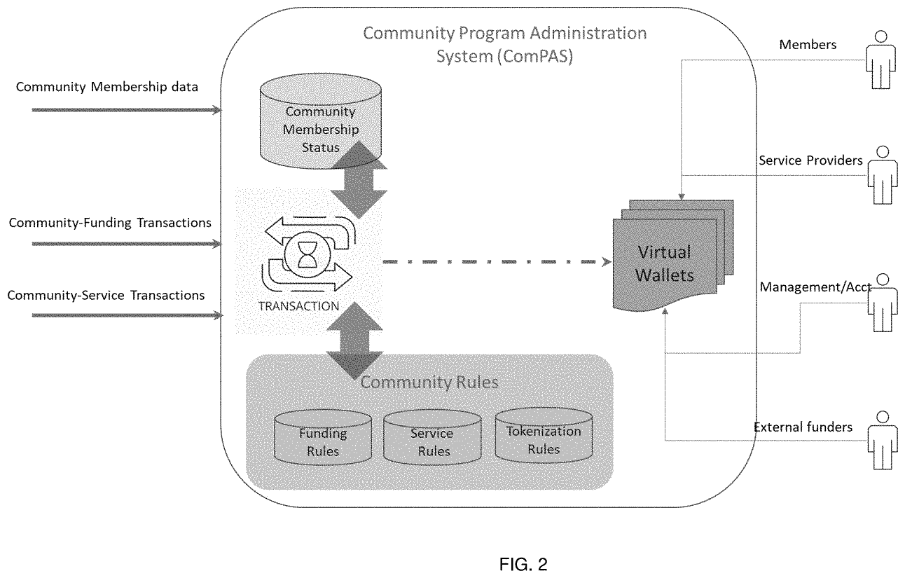

FIG. 2 shows an example of a ComPAS system schematic. As shown in FIG. 2, certain embodiments can comprise community membership data, community-funding transactions, and/or community-service transactions, which can be input into the ComPAS system. A ComPAS system can comprise community membership status data which can be input into a transaction loop that assesses and operates community rules. Community rules can comprise funding rules, service rules, and/or tokenization rules. The transaction loop can also interface with one or more virtual wallets. The one or more virtual wallets can correspond with one or more associated members, one or more service providers, one or more management accounts, and/or one or more external funders. Tokenization rules can also be utilized to manage other transactions, such as cross-border payments.

Systems described herein can utilize multiple forms of automated data collection interfaces. For example, automated data collection interfaces can include member payment transactions, claims, expenses, and the like. During execution, interfaces can be designed to address situational needs. As an example: if a large claim is being paid out and the system is out of funds in the accounts, the system can create an interaction with an administrator to seek permission to overrule a large claim and pay out other smaller claims if funds are available. The administrator can execute several options, including moving monies from one or more administration wallets to satisfy the claim need. In other instances, the administrator may suspend all operations until new monies collected are brought into the system (e.g., via funding or other contribution).

Systems described herein can be configured to obviate one or more members' need for having individual accounts at financial institutions via implementation of features of the embodiments described herein, such as virtual wallets. Virtual wallets, as described herein, can be utilized to eliminate risk for community members, such as the risk associated with comingling or pooling of funds (e.g., via funding transactions described herein), and can allow a community to maintain integrity of individual member accounts with any fiat funds maintained within the system, such as with one or more capital concentration accounts.

In some embodiments, process and data orchestrations can be executed by the system. In some instances, a particular orchestration can be incorporated into a system and chosen based upon its desired function of the algorithm, community rules, escalation mechanisms, and the like.

As described herein, a ComPAS architecture can be described by schematic processes defined by transactions using configurable rule sets to create a fully auditable, peer-to-peer view of virtual accounts in a system. In some embodiments, transactions are processed by rules alone. In some embodiments auditing processes can access and/or validate the processing of data through the system, or trace data backwards from an individual wallet to the original transaction or to the source of funds.

System auditing can occur in multiple ways. In some embodiments, each member can be assigned a unique identifier that can be used to qualify relevant transactions/activities/events. In some embodiments, system auditing can generate reports, wherein reports can provide raw transaction level details, view of specified rules, wallet allocation processing based on the specified rules, and/or the ability to trace all transactions at an individual or aggregate wallet level. System-level rules may be executed and/or orchestrated using blockchain or non-blockchain implementation patterns. System auditing can be utilized to determine the “health” of a system. Herein, the “health” of a system can be determined based on predetermined criteria, such as whether the system is “in the black”, i.e., it has adequate or excess funding inflows vis-à-vis its obligations to meet valid expenses from community members. A system's health can be considered a measure or state of a community's financial viability. System health can be determined by a formal actuarial model for a community's proposed transactions, such as an insurance premium determination based on analysis of claims for a target community.

Certain embodiments comprise community-funding transaction processing rules. Such rules can relate an input value processing (e.g., funds or other) based on the community construct. Some examples include, but are not limited to:
A self-funded employer (i.e., the “Community”) collects monthly premium dollars to pay for eligible employee's healthcare services
Members send monthly contributions to a HealthShare ministry (i.e., the “Community”) to pay for sharable healthcare services of other members
A residential association (i.e., the “Community”) collects fees for defined maintenance services shared within the community
An employer pays a portion of the employee's premium dollars monthly
A benefactor in a HealthShare ministry donates dollars to be used for specifically sharing medical expenses of military veterans

In an exemplary embodiment, a community health share program can be administered through ComPAS. In exemplary embodiments, a monthly community subscription transaction of a fixed dollar amount, for example $15, can utilize:
a % to be payable towards a merchant processing fees, if by card
z % to be payable to a sales channel as commission
wherein the remainder of the fixed dollar amount can be allocated to a member's wallet

In another exemplary embodiments, a monthly health share contribution transaction of a fixed dollar amount, for example $X, can require:
a % to be payable towards merchant processing if by card
y % as sales commission
wherein a remainder can be allocated to one or more members' wallet
an approved expense (claim) of $1000 with OOP $200:

In some embodiments, members can be rewarded based on a particularly defined status. For example, if a member is a military veteran, an amount of funds can be added to the payout to a provider from a veteran support wallet, or common fund-portion of a system with rules defining allocation to members who are military veterans.

In some embodiments, following allocation, any remainder amounts can be allocated in a round robin fashion from member wallets to other members, as defined by the rules.

Certain embodiments comprise tokenization rules. Tokenization can create fungible credits that can be used as currency for value exchange within a community, thus normalizing the value of community-funding transactions. Examples include, but are not limited to:
Aemployee contributes $100 towards monthly premium, which is converted into 100 “ComPAS tokens” (in this case there is a 1:1 relationship)
As an incentive to participate in a weight loss program, a self-funded employer contributes 100 ComPAS tokens for every pound lost. These tokens can be earned and used to pay towards an OOP portion of claims submitted by the employee. Such an embodiment can be characterized as a gamification example in that members are rewarded for achieving certain objectives
Members in a HealthShare ministry can make extra contributions to support high value claims for needy members to earn enough ComPAS tokens to upgrade their health sharing program; in some instances, the value of the contributions (ComPAS tokens earned) can be a function of fund-raising campaign goals within the community—e.g., a $50 contribution in campaign 1 can result in 50 tokens, and 100 tokens in campaign 2.

Certain embodiments can comprise community-services transaction processing rules. ervices availed in the community can result in execution of several rules for processing the transactions. In some embodiments, a HealthShare ministry may implement a round robin algorithm for sharing medical expenses. For example, member wallets can be debited in a round robin fashion to meet the sharable medical expense. In some embodiments, an employer wants to pay OOP expenses of all military veterans in the company; while processing claims of this nature, the OOP portion could be transferred directly to a provider from the employer's OOP wallet.

A round-robin algorithm (i.e., one in which actions are addressed in sequence) can be one of the algorithms that can be used for processing; other algorithms can perform different tasks depending upon the objectives of a community. In a HealthShare ministry application, the use of a round robin algorithm can ensure an equitable method of sharing eligible expenses. The sequencing of sharable expenses can be based on the order of determination of adjudication (e.g., time of adjudication).

The following are some of the “high priority” use cases that demonstrate the applicability of embodiments of the disclosure, as described herein, within the marketplace.

Some embodiments can comprise a self-funded health insurance employer market. Self-funded employers can design specific health plans to meet employee's needs. This can be achieved via a broker relationship with a third party administrator (TPA) that can handle claims processing, customer service, and other services. TPAs can charge a per member per month (PMPM), a per household per month (PHPM), or a per employee per month (PEPM) set of fees based on a variety of services that can be included and defined within any given system.

While TPAs can provide several reports and metrics to monitor the health of the program in terms of health services utilization, they usually do not (or are unable to) provide transparency in administration of a program. Using ComPAS community-funding transaction processing rules, as described herein, TPAs can better identify how incoming premium contribution dollars are being used at the community level and the individual employee level providing greater administration transparency, thus improving over conventional methods and systems of the prior art.

A community is not particularly limited in the way it can introduce funding.

For example, HCSMs can utilize member-to-member (peer-to-peer) sharing of eligible member needs. Using ComPAS community-funding rules, as described herein, HCSMs can identify the exact sharable amount in individual member wallets. Further, using ComPAS community-services rules, as described herein, eligible needs can be debited from individual member wallets, providing member-to-member sharing in the system. Also, providers can be directly paid via wallet-to-wallet transfers from individual member wallets to provider wallets mapped in the system.

In certain embodiments, a system, as described herein, may comprise user wallets. User wallets can be virtual fund allocation locations within the system and in some instances, primarily form an auditable account balance. Using an auditable stream as a source of funds, the system can be integrated into and interface with treasury, banking application programming interfaces, or systems to effect the changes in corresponding physical accounts.

Certain embodiments can comprise community health plans. In some embodiments, community health plans can be nonprofit payor-organizations. Community health plans can be functionally similar to sharing organizations, except that they may offer a product subject to and governed by additional regulation, such as healthcare laws.

Certain embodiments comprise association health plans. These plans can be a type of community health plan offering. Association health plans can be formed via industry vertical associations. Industry vertical associations can be one or more entities or consumers who have a reason to form a community around shared interest or outcome. A typical industry vertical association is based on standard industrial codes (SIC) in a domain. For example, “Steel Workers of Pennsylvania” can bring together steel workers (businesses/sole-proprietors/1099s) operating in Pennsylvania. Certain embodiments can comprise rules to govern the transactions within an association health plan. Other examples of association health plans are AFMC (“Arizona Foundation for Medical Care”), which brings together provider offices and represents their common needs in Arizona. Such systems can be used in many industry associations, including both national and regional chapters of organizations.

Systems described herein can be utilized in other types of organizations including co-operatives, barter-exchange communities, and collector clubs.

As described herein, systems can be utilized in communities and can manage eligibility of its members to provide services. In most cases, this requires timely contributions from members towards community fees, and related subscriptions. In systems described herein, there may be other means of determining eligibility based on the rules of the system rules that are defined by the community rules.

Based on previous contribution patterns and the eligibility-through processing, a system, as described herein, can predict the timing and amount of an upcoming contribution from a contributor. Systems described herein can provide interfaces to a community to trigger communications with members. Interfaces could be in the form of reminders, invoices, automatic drafts, and the like.

In some embodiments, the system, as described herein, can automatically originate recurring subscription payments using a secure recurring payment process. The recurring payment process can be effectuated via an inbuilt payment gateway access. Additionally, members of a community may defer payments or may have payment vehicles that are no longer valid (e.g., no funds in a bank account, or an expired card). In such situations, a system, as described herein, creates a report for the community to take further action to provide a community-based solution.

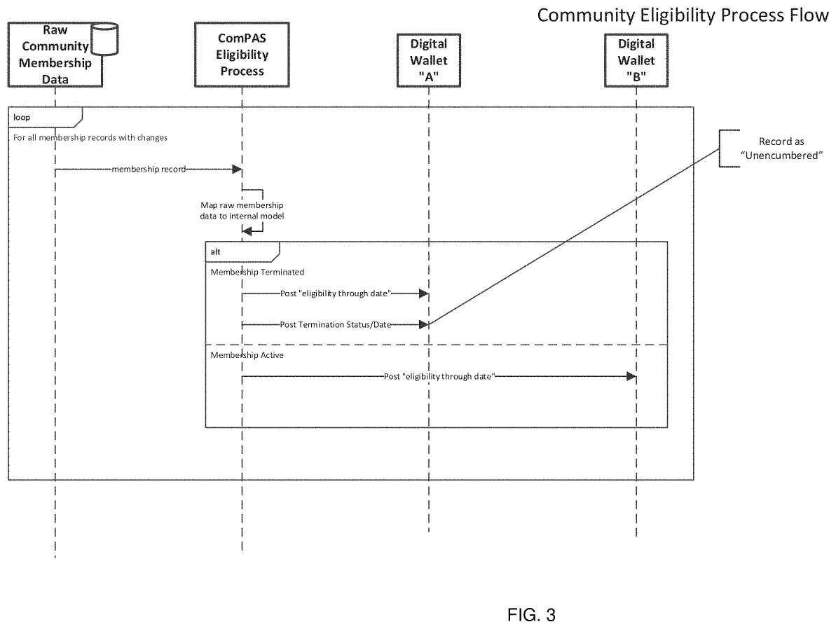

FIG. 3 shows an example of a community eligibility process flow that can be implemented using the systems described herein. As shown in FIG. 3, raw community membership data can be input into a community eligibility management process. The raw community membership data can form one or more membership records that are utilized during a ComPAS eligibility process. The ComPAS eligibility process can map raw membership data to an internal model. In the event the ComPAS eligibility process requirements are not satisfied, a membership within a community may be terminated. If a membership is terminated, the system can record and post a termination status date shared with other members of the community. Membership may also be terminated or remain active via an “eligibility through date,” which can be a predetermined date on which a membership is automatically terminated. If the system posts a termination status of a member, the status can be recorded as unencumbered. Termination data can be housed in a separate digital wallet (e.g., digital wallet “A”) than a digital wallet housing active membership data (e.g., digital wallet “B”).

To provide services, an eligibility through date can be implemented as an attribute that determines the cut-off date for community-services to be availed. As an example, an employee cannot utilize medical services that are community-funded by an employer, if said employee has left employment with said employer. Conversely, an ex-employee's healthcare claims must be met by the community, if the claims came in prior to the “eligibility through date” for a service that was rendered before the “eligibility through date.”

Certain embodiments can comprise a community funding transaction (“TXN”) processing including tokenization. In some embodiments, when TXNs are integrated into the ComPAS process, as described herein, TXNs can be processed according to a community's rules for administration and allocation, which are implemented and effectuated by the system. Prior to processing the funding TXN, a TXN may undergo a tokenization based on tokenization rules.

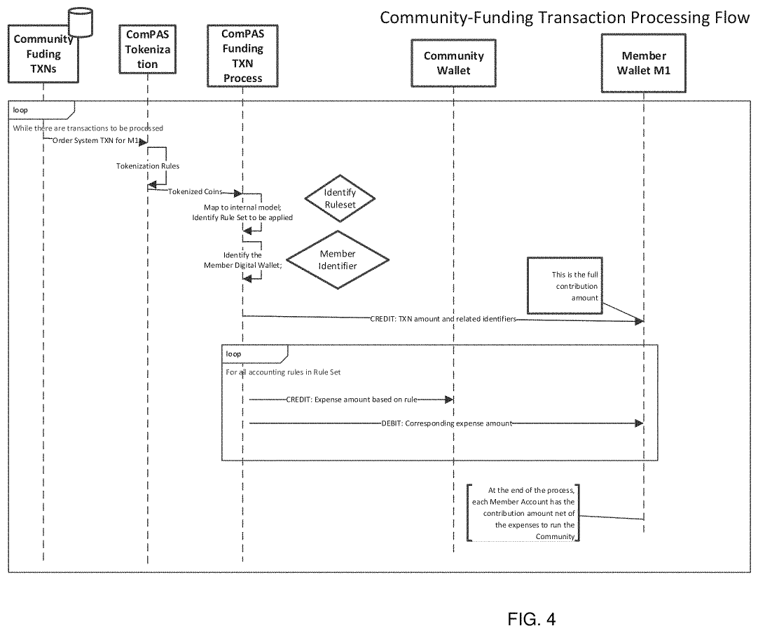

FIG. 4 shows an example of TXN processing flow diagram. Some embodiments can comprise one or more TXNs, a ComPAS tokenization, a ComPAS funding transaction process, a community wallet, and one or more member wallets. As used in FIG. 4, “Ml” can refer to one particular member, though the number of members in the process flow is not particularly limited. The process can be effectuated upon operation of an order system transaction for Ml, wherein the transaction is subjected to tokenization rules. The system can then implement tokenization and/or provide coins, which can be mapped to an internal model that can identify a proper rule set to be applied and identify a corresponding member digital wallet affected by said rule. In a second loop, the system can operate accounting rules in a corresponding rule set. The second loop can issue one or more credits comprising an expense amount based on one or more rules. The credit can be issued utilizing a ComPAS funding transaction process to issue the credit to the community wallet. The second loop can also issue a debit, comprising an expense amount, wherein the debit may be issued utilizing a ComPAS funding transaction process, wherein the debit is issued to a corresponding member wallet. At the end of the process depicted in FIG. 4, each member account has a contribution amount net of any expenses to run the associated community.

Tokenization rules can be special community rules tied to TXNs. TXNs need not be “cash in” transactions only, but may also be transactions that allow for “mining of tokens.” As an example, a community may decide to reward members who successfully participate in wellness programs with additional tokens to be used for OOP payments. OOP payments can be credited into a member's virtual wallet as special ComPAS tokens that are to be used specifically for OOP payments.

TXNs can be provided as subscription fees or monetary contributions, which can be handled using community-funding rules for allocation to community (expense) wallets and/or member wallets.

In some embodiments, tokenization can be utilized to allow the system to assign a value ascribed to a transaction. For example, tokenization, as used herein, can be the value of the dollar amounts coming into a system via funding transactions. For instance, a $100 monthly premium contribution can create 100 tokens. By assigning a value to a transaction, this can advantageously allow a system to handle cross-currency transactions within the system by providing a ubiquitous currency (i.e., tokens) amongst the members of a community.

Systems described herein can assign value to non-monetary transactions as value to a community. As an example: an employer can pledge a certain number of tokens (e.g., 5 tokens a month) for a particular outcome, such as a body mass index (BMI) “goal” of no more than 22.5 per employee. A human resource department can distribute an application that reports the BMI per employee (the system need not know how the BMI is computed by the application; the interfaced application need only input the result into ComPAS). For every BMI reported less than or equal to a certain amount (e.g., 22.5), the predetermined number of tokens (e.g., 5 tokens) can be added to the employee's wallet (via tokenization rule for this type of transaction), thus increasing a token balance available for paying an expense.

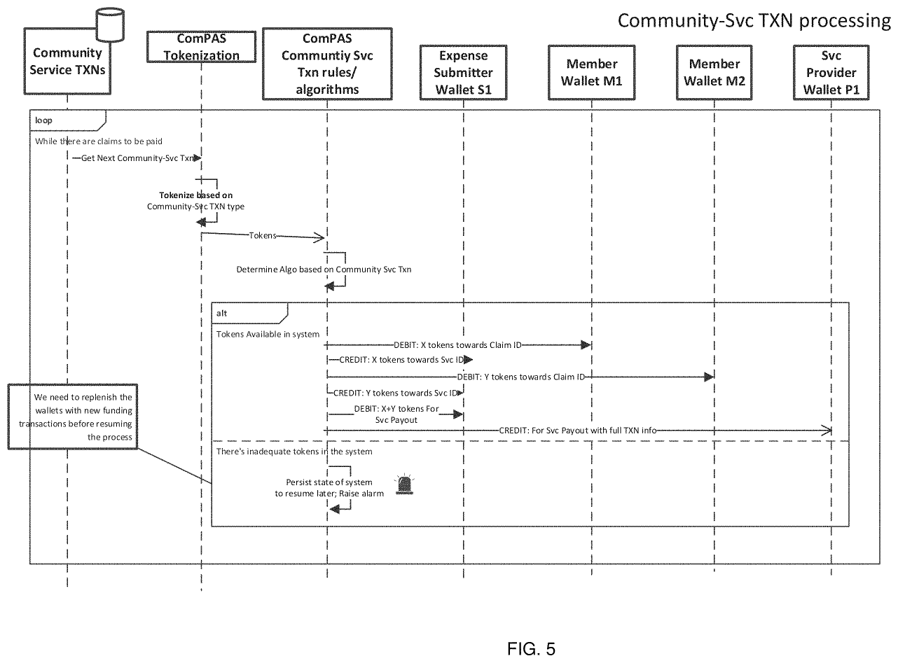

FIG. 5 shows an example of community service transaction processing. As shown in FIG. 5, a community service transaction process flow can comprise community service transactions, ComPAS tokenization, ComPAS community service transaction rules, ComPAS community service transaction algorithms, an expense submitter wallet (e.g., “S1”), one or more member wallets (e.g., “M1” and “M2”), and/or a service provider wallet (e.g., “P1”). The community service transaction processing process can operate in a loop while there are transactions to be a paid. Upon receiving instructions to initiate a community service transaction (and each subsequent such transaction), tokenization can occur based on the type of community service transaction. Tokens can then be issued utilizing the ComPAS community service transaction rules and/or algorithms; wherein the particular rules and/or algorithms are chosen as a result of the type of community service transaction.

As further shown in FIG. 5, once one or more tokens are available in a system (such as one utilizing the community service transaction processing flow shown in FIG. 5), the one or more tokens can be utilized in one or more ways including, but not limited to: the one or more tokens being debited towards identification of a claim; the one or more tokens being credited towards a service identification; a debit toward a service payout comprising the sum of one or more tokens that have been allocated toward identification of a claim and one or more tokens allocated toward a service identification; and/or a credit for one or more service payouts with full transaction information. In the event that there are inadequate tokens in the system, the system can raise an alarm and put the system in a “stopped” state, wherein the system will resume at a later time, such as when adequate tokens are in the system.

In some embodiments, a transaction can first be tokenized for processing within a community system. Depending upon the transaction type, a ComPAS system can determine the proper predetermined community rules and/or algorithm to apply. Based on the algorithm/rule, the value exchange endpoints and the value amounts can be determined.

In some embodiments, a HCSM may use a round robin scheme for paying out needs and claims. Member wallets may be debited in sequence to pay for adjudicated claims. A claim can have an OOP portion that is reimbursed via a special benefactor wallet in the system.

In some embodiments, a service provider's wallet can be credited with the total tokens determined.

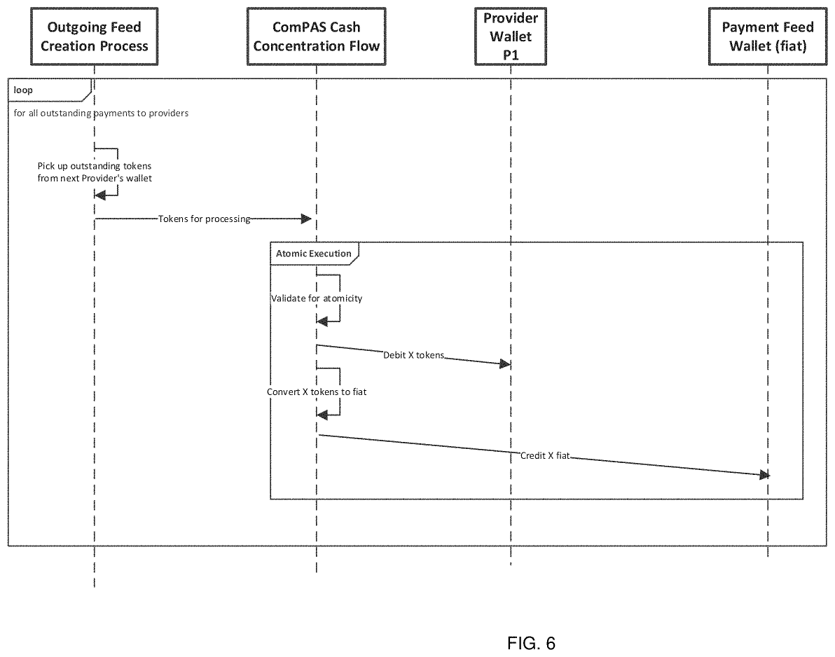

FIG. 6 shows an example of a capital/cash concentration flow. In some embodiments, a capital/cash concentration flow can comprise an outgoing feed creation process, a ComPAS cash concentration flow, a provider wallet (e.g., “P1”), and/or a payment feed wallet. As shown in FIG. 6, a system can operate a loop for all outstanding payments to providers. The system can pick up outstanding tokens from a provider's wallet wherein the tokens are utilized for processing. The system can then atomically execute one or more functions that can validate for atomicity, debit one or more tokens, convert one or more tokens to fiat, and/or credit the value of the one or more tokens as fiat.

Systems described herein can use a virtual account management strategy utilizing one or more ComPAS tokens represented in one or more virtual accounts. For outgoing payments, a cash concentration flow can be executed that converts the one or more tokens into fiat in a cash concentration account. The conversion of one or more tokens into fiat in a cash concentration account can be translated into a banking API/feed transaction that moves money from a cash concentration account to pay payors.

In some embodiments, a virtual account management platform can allow for direct debits and credits into one or more virtual accounts created in the system. A ComPAS system, as described herein, can create a transactional layer that can reside above actual debits and credits occurring within the system. The transactions posted can go through the system's tokenization and rules, which, in turn, can convert the appropriate value into debits and credits into the virtual account system. Other virtual account management systems need not have this rules based provisioning strategy. The execution of these rules can be fully auditable at an individual virtual account level.

Certain embodiments can comprise implementation patterns. In some embodiments, a ComPAS schema may be implemented across several technology patterns. Following are some examples of implementation embodiments:

A microservice and immutable ledger database

An enterprise blockchain system

A microservice architecture & SQL database

In a microservice and immutable ledger database embodiment, the ComPAS schema may be implemented using a microservices execution architecture using an immutable ledger database. This implementation pattern can be deployed for a HCSM customer.

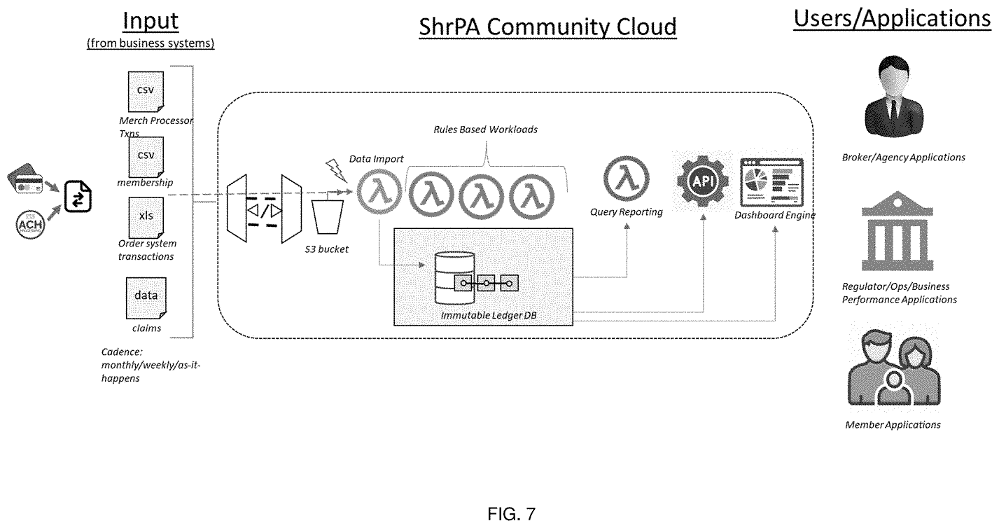

FIG. 7 shows an example of a microservice and immutable ledger database system. As shown in FIG. 7, a microservice and immutable ledger database can comprise one or more inputs, a “ShrPA Community Cloud,” one or more users, and one or more applications. The one or more inputs can comprise one or more merchant processor transactions, one or more membership databases, one or more order system transactions, and or more datasets for claims. An immutable ledger database can import data, be based on rules-based workloads, and interface with query reporting, one or more APIs, and/or a dashboard engine. The one or more applications can comprise broker/agency applications, regulatory/operations/business performance applications, and/or member applications.

ShrPA community cloud can be implemented over a blockchain platform, such as Hyperledger using constructs like smart contracts to tokenize and route ledger transactions.

In an enterprise blockchain system embodiment, modeling the community on the blockchain can have several advantages including immutability, robust consensus, cryptographic framework, transparency, and anonymity of private transaction information. Tokenization may be native to blockchain systems.

In a microservices architecture & SQL database embodiment, several robust transactional systems can be designed using SQL databases and microservices frameworks. This design may be employed for a ComPAS implementation.

While a number of exemplary embodiments, aspects and variations have been provided herein, those of skill in the art will recognize certain modifications, permutations, additions and combinations and certain sub-combinations of the embodiments, aspects, and variations. It is intended that the following claims are interpreted to include all such modifications, permutations, additions and combinations and certain sub-combinations of the embodiments, aspects and variations are within their scope.

1. A system for establishing a community-sharing transaction platform comprising:
a community comprising one or more members;
a computer readable medium and one or more processors operating the system; and
rules of engagement that define how one or more transactions are processed by the system and how one or more services are processed within the community, wherein the rules of engagement are defined and operated utilizing one or more algorithms that use a business rules modeling language.

2. The system of claim 1, wherein the system further comprises an immutable peer-to-peer virtual wallet view.

3. The system of claim 1, wherein the rules of engagement comprise a virtual, community rules-based virtual account management system configured to enable capital concentration flow, wherein the capital concentration flow comprises an outgoing feed creation process, a provider wallet, and a payment feed wallet.

4. The system of claim 1, wherein the system is configured to obviate the need for one or more members to have individual accounts at financial institutions, via implementation of the virtual wallets.

5. The system of claim 1, wherein the system applies one or more community rules for processing one or more community-funding contributions.

6. The system of claim 1, further comprising a payables wallet view in the system.

7. The system of claim 1, wherein the system is configured to tokenize community-funding contributions based on rules.

8. The system of claim 1, wherein the system is configured to withdraw tokenized funds from one or more virtual wallets to pay for community services using a community rules based-algorithm.

9. The system of claim 1, wherein the system creates a community token economics implementation to support cross-border payments.

10. The system of claim 1, wherein the system reports the health of the community by auditing a quantum of funding contributions, payouts for community services, and wallet counts.

11. The system of claim 1, wherein community rules can be codified in one or more executable templates to spin up community installations for verticals associations, wherein the community rules can be selected from the group consisting of community-funding processing rules, community-services processing rules, tokenization rules, and any combination thereof.

12. The system of claim 1, wherein the system tracks fund flows in a community environment.

13. The system of claim 1, wherein the system automatically originates recurring subscription payments using a secure payment process, wherein the recurring payment process is effectuated via an inbuilt payment gateway process.

14. The system of claim 1, wherein the system further comprises a community eligibility process flow, wherein raw community membership data can be input into a community eligibility management process.

15. The system of claim 1, wherein the system further comprises one or more community funding transactions.

16. The system of claim 1, wherein the system further comprises tokenization, wherein the tokenization is mapped to an internal model that can identify a rule set to be applied based on predetermined criteria.
